(19) United States
(12) Patent Application Publication
(10) Pub. No.: US 2016/0035508 A1
(43) Pub. Date: Feb. 4, 2016

(54) LIGHTING SWITCH FOR DISPLAY UNIT

(71) Applicant: YAZAKI CORPORATION, Minato-ku, Tokyo (JP)

(72) Inventor: Atsuro Murata, Shizuoka (JP)

(73) Assignee: YAZAKI CORPORATION, Tokyo (JP)

(21) Appl. No.: 14/775,383

(22) PCT Filed: Mar. 28, 2014
(86) PCT No.: PCT/JP2014/059371

§ 371 Date: Sep. 11, 2015

(30) Foreign Application Priority Data
Apr. 23, 2013 (JP) 2013-090585

(51) Int. Cl. H01H 9/18

(52) U.S. Cl. CPC H01H 9/182

(57) ABSTRACT

Switch knobs have indication portions that are provided with various indications. The indications provided in the indication portions can transmit light that is emitted from a light-emitting diode and guided by a light guide member. The optical axes (Ax) of light beams that are emitted from the light-emitting diode and guided by the light guide member are directed to the eye points (IPd, IPn) of persons who are to manipulate the switch knobs, respectively.

### TECHNICAL FIELD

The present invention relates to a switch with a luminous indication portion in which the luminous indication portion lights being illuminated by a light source.

### BACKGROUND ART

As shown in FIG. 14, a vehicular room illumination device is known in which the viewability, in dark places (e.g., at night), of indications of switch knobs 2 for turning on or off respective lamps 1 is enhanced by causing indication portions 3 of the respective switch knobs 2 to light (refer to Patent document 1).

As shown in FIG. 15, this vehicular room illumination device is equipped with a light source 5 which is attached to a housing 4. The switch knobs 2 are disposed in front of the light source 5. A light guide member 6 for guiding light emitted from the light source 5 to the back surfaces of the switch knobs 2 is disposed in the housing 4. The indication portions 3 of the switch knobs 2 are illuminated with light beams that are emitted from the light source 5 and guided by the light guide member 6.

### PRIOR ART DOCUMENTS

### Patent Documents

Patent document 1: JP-A-2013-30311

### SUMMARY OF THE INVENTION

### Problems to Be Solved by the Invention

Incidentally, the above-described vehicular room illumination device is attached to a ceiling at a position that is located over the boundary between the driver's seat and the front passenger seat in a vehicle. To illuminate the driver's seat side, the driver's-seat-side lamp 1 is turned on by pushing the driver's-seat-side switch knob 2. To illuminate the front passenger seat side, the front-passenger-seat-side lamp 1 is turned on by pushing the front-passenger-seat-side switch nob 2.

However, in the above-described vehicular room illumination device, light that is emitted from the light source 5 and shines on the back surfaces of the switch knobs 2 via the light guide member 6 is incident on the front surfaces of the switch knobs 2 vertically. As a result, light beams that are emitted from the indication portions 3 of the switch knobs 2 (i.e., from the vehicular room illumination device) go right downward toward the boundary between the driver's seat and the front passenger seat. Therefore, the switch knobs 2 look dark from the driver's seat or the front passenger seat, and hence indications on the switch knobs 2 are low in the viewability from the driver's seat or the front passenger seat.

The present invention has been made in the above circumstances, and an object of the invention is therefore to provide a switch with a luminous indication portion that is superior in the viewability from a person who manipulates it.

### Means for Solving the Problems

To attain the above object, the switch with a luminous indication portion according to the invention is characterized by the following items (1)-(3):

(1) The switch with a luminous indication portion comprises:

a switch;

a switch knob which is provided in the switch and is configured to be manipulated in switching the switch; and

a light source which illuminates the switch knob with light from a back side of the switch knob,

wherein the switch knob includes an indication portion that is provided with a certain kind of indication;

wherein the indication provided in the indication portion is configured to transmit light coming from the light source; and

wherein an optical axis of the light coming from the light source is directed to an eye point of a person who is to manipulate the switch knob.

(2) The switch with a luminous indication portion having the configuration of the above item (1), further including a light guide member which guides light emitted from the light source to the back side of the switch knob and emits the light through a light exit surface as an end surface toward the indication portion,

wherein a portion, adjacent to the light exit surface, of the light guide member extends toward the eye point so that the light exit surface is directed to the eye point.

(3) The switch with a luminous indication portion having the configuration of the above item (1), further including a light guide member which guides light emitted from the light source to the back side of the switch knob and emits the light through a light exit surface as an end surface toward the indication portion,

wherein the light exit surface of the light guide member is inclined with respect to an extending direction of a portion, adjacent to the light exit surface, of the light guide member so that the light exit surface is directed to the eye point.

In the switch with a luminous indication portion having the configuration of the above item (1), since light that is incident on the back side of the switch knob is guided so as to pass through the indication of the indication portion and to be output to a front-side space, the indication of the indication portion can be recognized visually even in dark places (e.g., at night).

Furthermore, since the optical axis of light coming from the light source is directed to the eye point of a person who is to manipulate the switch knob, the viewability from the person who is to make a manipulation can be enhanced greatly. Still further, the indication of the indication portion is less visible from positions other than the eye point of the person who is to make a manipulation, which make it possible to suppress the probability of occurrence of an erroneous manipulation by a person other than the person who is to make a manipulation (i.e., a person not to make a manipulation).

In the switch with a luminous indication portion having the configuration of the above item (2), since a portion, adjacent to the light exit surface, of the light guide member for guiding light emitted from the light source toward the back side of the switch knob extends toward the eye point so that the light exit surface is directed to the eye point, the optical axis of light that comes from the light source and is emitted from the light exit surface can reliably be directed to the eye point of a person who is to manipulate the switch knob. As a result, the viewability from the person who is to make a manipulation can be enhanced greatly.

In the switch with a luminous indication portion having the configuration of the above item (3), since the light exit surface of the light guide member for guiding light emitted from the light source toward the back side of the switch knob is inclined from the plane perpendicular to an extending direction of a portion, closest to the light exit surface, of the light guide member so that the light exit surface is directed to the eye point, the optical axis of light that comes from the light source and is emitted from the light exit surface can reliably be directed to the eye point of a person who is to manipulate the switch knob. As a result, the viewability from the person who is to make a manipulation can be enhanced greatly.

### Advantages of the Invention

The invention makes it possible to provide a switch with a luminous indication portion(s) that is superior in the viewability from a person who manipulates it.

The invention has been described above concisely. The details of the invention will become more apparent when the modes for carrying out the invention (hereinafter referred to as embodiments) described below is read through with reference to the accompanying drawings.

### BRIEF DESCRIPTION OF THE DRAWINGS

FIG. 1 is a perspective view of a vehicular room illumination device that is equipped with a switch with luminous indication portions according to an embodiment.

FIG. 2 is a perspective view, as viewed from the back surface side, of the vehicular room illumination device that is equipped with the switch with luminous indication portions according to the embodiment.

FIG. 3 is an exploded perspective view of the vehicular room illumination device.

FIGS. 4(a)-4(j) are perspective views showing interim assembling states of the vehicular room illumination device, and illustrate an assembling method of the vehicular room illumination device.

FIG. 5 is a perspective view of the switch with luminous indication portions according to the embodiment.

FIG. 6 is a sectional view of the switch with luminous indication portions according to the embodiment.

FIG. 7 is a perspective view of a switch knob.

FIG. 8 is a plan view of the switch knob.

FIG. 9 is a perspective view of a transparent portion of the switch knob.

FIG. 10 is a front view of the light guide member.

FIG. 11 is a perspective view showing a vehicle inside space in which the vehicular room illumination device is installed.

FIG. 12 is a sectional view of the switch with luminous indication portions and shows its optical paths.

FIG. 13 is a sectional view of a switch with luminous indication portions according to another embodiment and shows its optical paths.

FIG. 14 is a plan view of a vehicular room illumination device for description of a conventional switch with luminous indication portions.

FIG. 15 is a sectional view of the vehicular room illumination device for description of the conventional switch with luminous indication portions.

### MODES FOR CARRYING OUT THE INVENTION

An embodiment of the present invention will be hereinafter described with reference to the drawings.

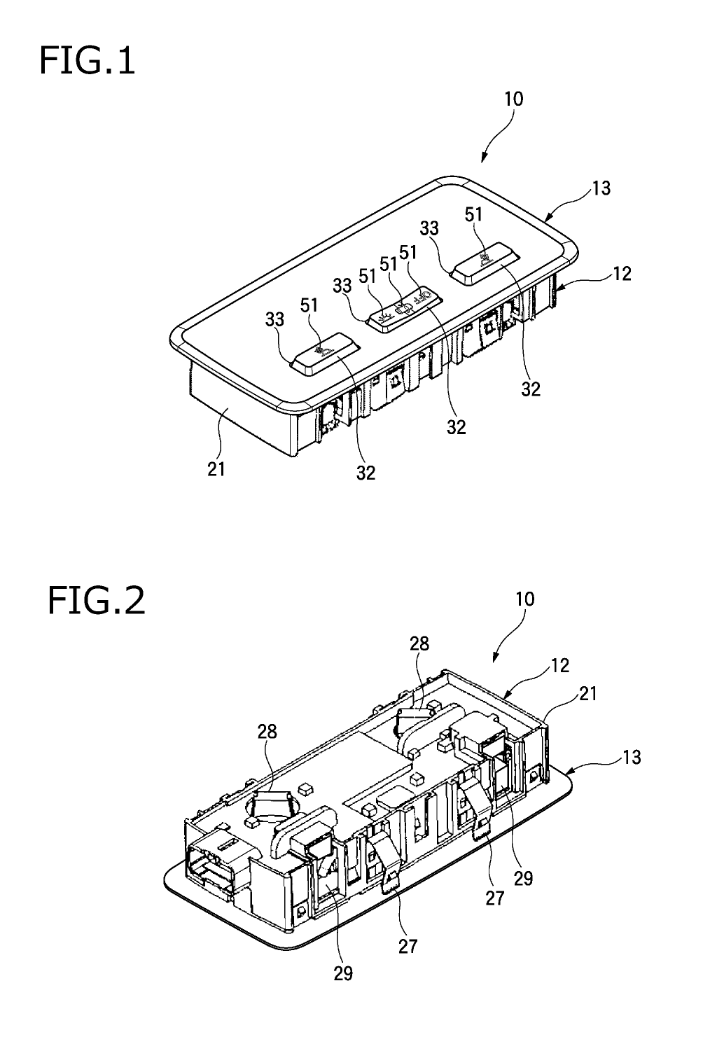

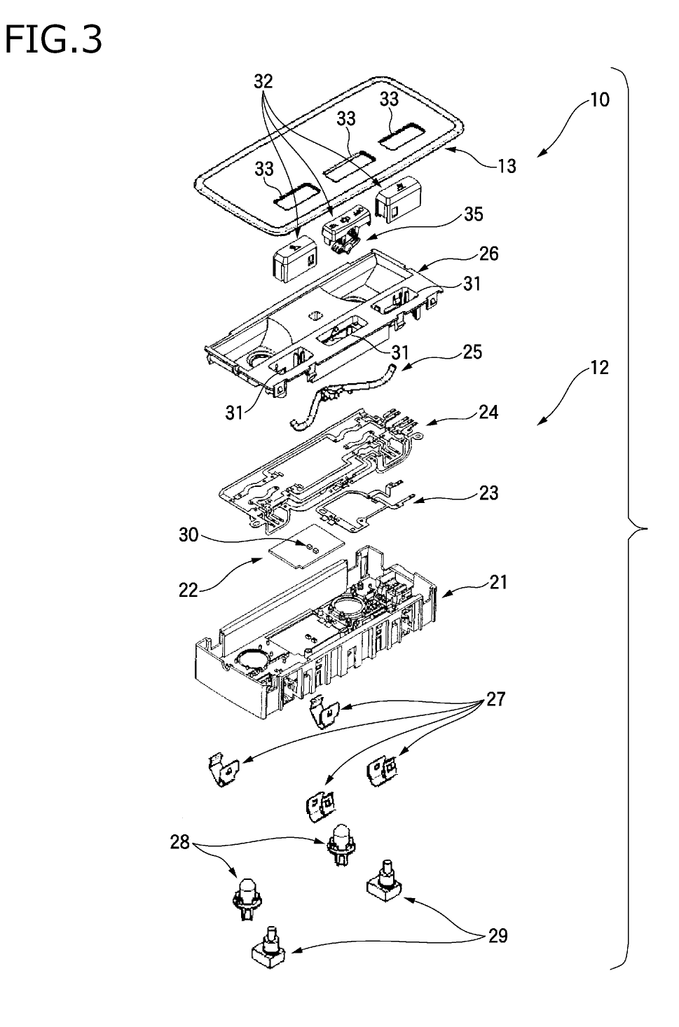

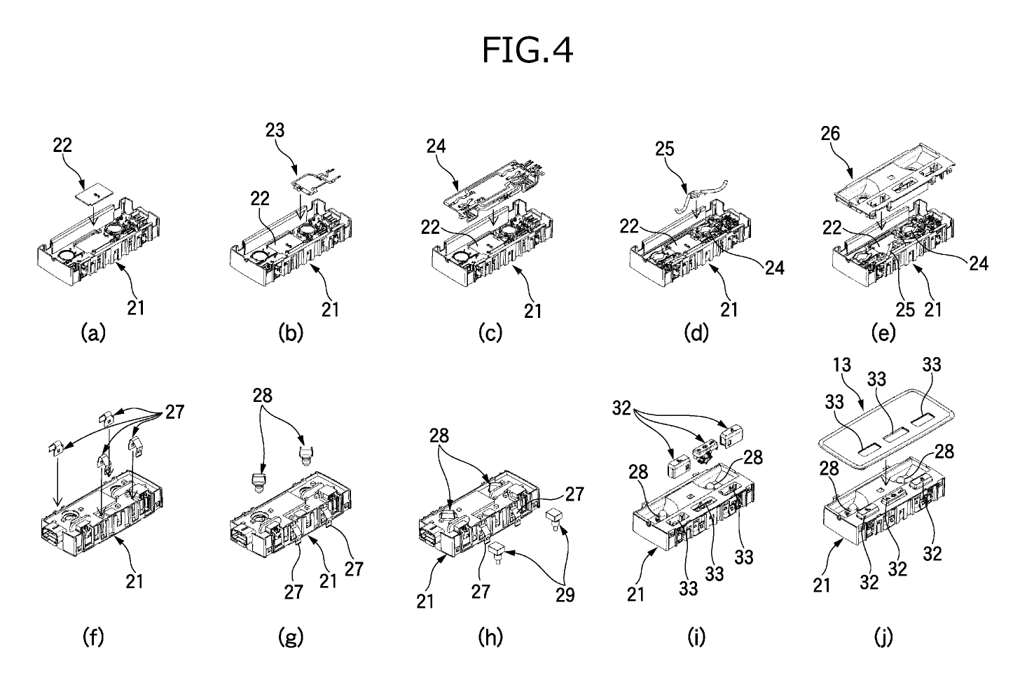

FIG. 1 is a perspective view of a vehicular room illumination device that is equipped with a switch with luminous indication portions according to the embodiment. FIG. 2 is a perspective view, as viewed from the back surface side, of the vehicular room illumination device that is equipped with the switch with luminous indication portions according to the embodiment. FIG. 3 is an exploded perspective view of the vehicular room illumination device. FIGS. 4(a)-4(j) are perspective views showing interim assembling states of the vehicular room illumination device, and illustrate an assembling method of the vehicular room illumination device.

As shown in FIGS. 1 and 2, the switch with luminous indication portions according to the embodiment is installed in the vehicular room illumination device 10. The vehicular room illumination device 10 has an illumination device main body 12 as a functional unit and a cover plate 13 as a decorative unit. The vehicular room illumination device 10 is attached to a vehicle ceiling by fitting it into an attachment hole formed in the vehicle ceiling with its illumination device main body 12 side directed to the vehicle ceiling.

As shown in FIG. 3, the illumination device main body 12 has a resin housing 21. In the housing 21, a circuit board 22, a sub-busbar 23, a main busbar 24, a light guide member 25, and an inner cover 26 are attached to the cover plate 13attachment side of the housing 21. Metal clips 27, bulbs 28, and push switches (switches) 29 are attached to the housing 21.

The inner cover 26 is formed with plural switch housing recesses 31 in which respective switch knobs 32 are housed.

The cover plate 13 is made of a transparent rein material and has a plate-like shape, and has plural switch holes 33. The switch holes 33 of the cover plate 13 are formed at such positions as to correspond to the switch knobs 32 which are housed in the switch housing recesses 31, respectively. Parts of the switch knobs 32 project through the respective switch holes 33.

The circuit board 22 is mounted with a light-emitting diode (LED) 30 which is a light source of the switch with luminous indication portions and emits light when supplied with power. The light guide member 25 leads light emitted from the light-emitting diode 30 to the switch knobs 32 by refracting and guiding it.

The sub-busbar 23 and the main busbar 24 are made of a conductive metal material such as copper or a copper alloy, and have prescribed shapes so that they function as prescribed electric circuits, respectively.

The bulbs 28 are light bulbs or the like that are turned on when supplied with power via the sub-busbar 23 and the main busbar 24. When the bulbs 28 are turned on, light emitted from them are radiated to inside the vehicle through the cover plate 13 and the vehicle inside space is thereby illuminated.

The push switches 29 are disposed at such positions as to correspond to the two respective side switch knobs 32 of the three switch knobs 32. The push switches 29 are pushed down and thereby switched on or off when the respective switch knobs 32 are pushed. A bulb 28 is turned on when the associated switch knob 32 is pushed and the associated push switch 29 is switched on. A bulb 28 is turned off when the associated push switch 29 is switched off.

A terminal metal fitting 35 made of a conductive metal material such as copper or a copper alloy is attached to the central switch knob 32. This switch knob 32 is a seesaw switch knob that is supported swingably. When this switch knob 32 is swung, the terminal metal fitting 35 is brought into contact with or separated from contacts that are formed on the sub-busbar 23 and the main busbar 24. That is, this switch knob 32 is a manipulation knob for a switch that is composed of the sub-busbar 23, the main busbar 24, and the terminal metal fitting 35. By swinging this switch knob 32, the vehicular room illumination device 10 is switched between an on-state in which the bulbs 28 are turned on, an off-state in which the bulbs 28 are turned off, and a door-mode state in which the bulbs 28 are turned on when a vehicle door is opened.

The metal clips 27 are made of a resilient metal material such as stainless steel and attached to side walls of the housing 21. The metal clips 27 are locked on a vehicle frame or the like when the vehicular room illumination device 10 is fitted into the attachment hole formed in the vehicle ceiling. As a result, the vehicular room illumination device 10 is attached to the vehicle ceiling.

To assemble the above-described vehicular room illumination device 10, first, as shown in FIG. 4(a), the circuit board 22 is attached to the housing 21. Then, as shown in FIG. 4(b), the sub-busbar 23 is attached to the housing 21. Furthermore, the main busbar 24 is attached to it as shown in FIG. 4(c). As a result, a prescribed electric circuit is formed by the sub-busbar 23 and the main busbar 24. Subsequently, the light guide member 25 is attached to the housing 21 as shown in FIG. 4(d) and the inner cover 26 is attached to it as shown in FIG. 4(e). After the attachment of the inner cover 26, the housing 21 is flipped and the metal clips 27 are attached to it as shown in FIG. 4(f) and then the bulbs 28 are attached to it as shown in FIG. 4(g). Then, as shown in FIG. 4(h), the push switches 29 are attached to the housing 21 from its side. The housing 21 is flipped again and the switch knobs 32 are housed in the respective switch housing recesses 31 of the inner cover 26 as shown in FIG. 4(i), and the cover plate 13 is attached to the housing 21 as shown in FIG. 4(j).

Next, the switch with luminous indication portions which is composed of the light-emitting diode 30, the light guide member 25, the push switches 29, the sub-busbar 23, the main busbar 24, the switch knobs 32, etc. will be described.

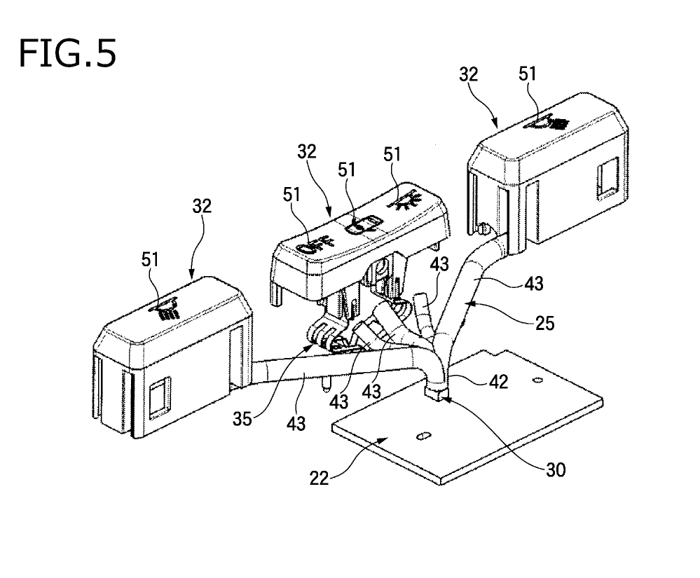

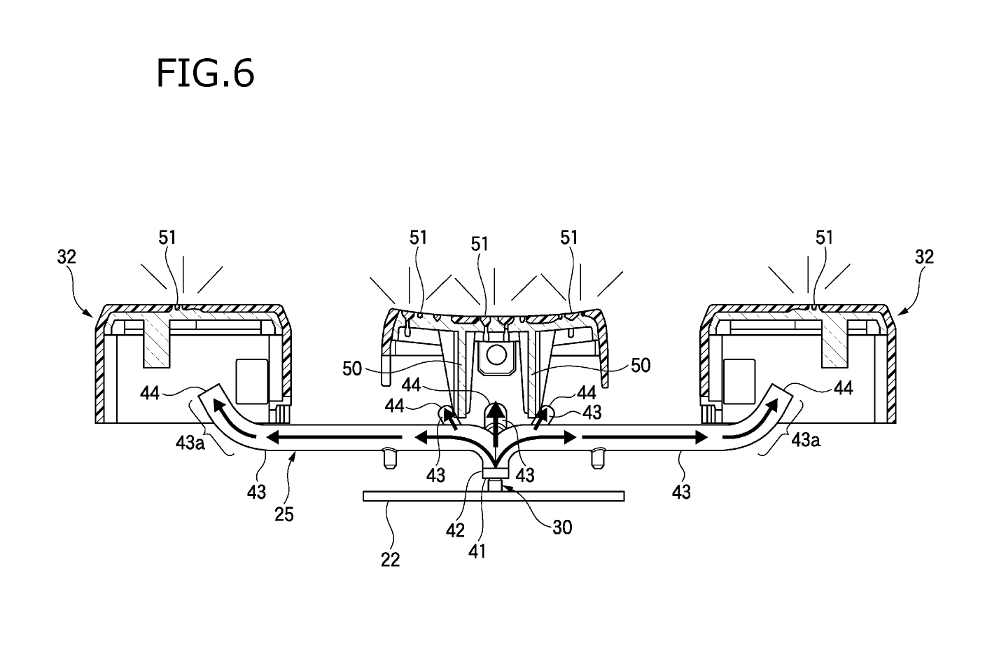

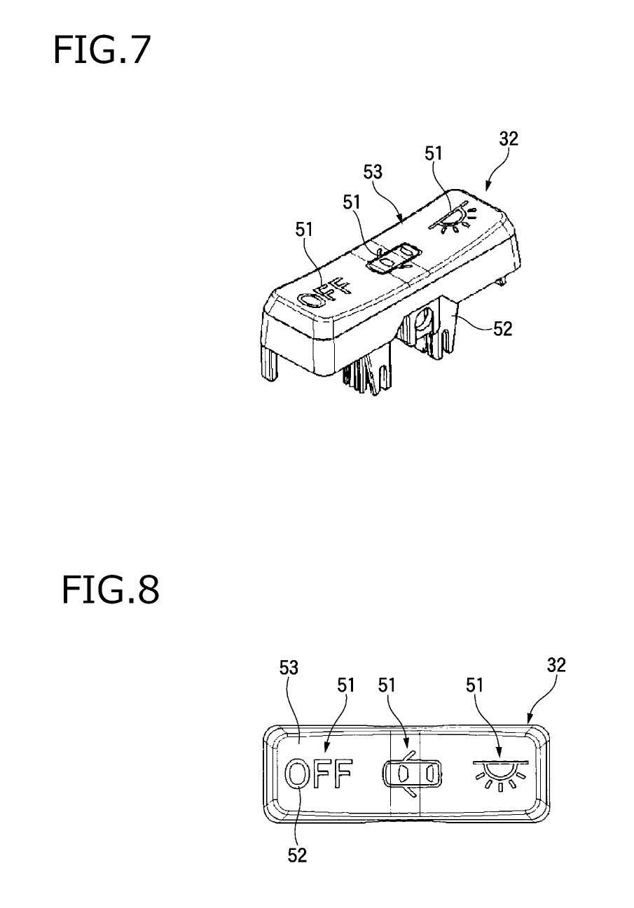

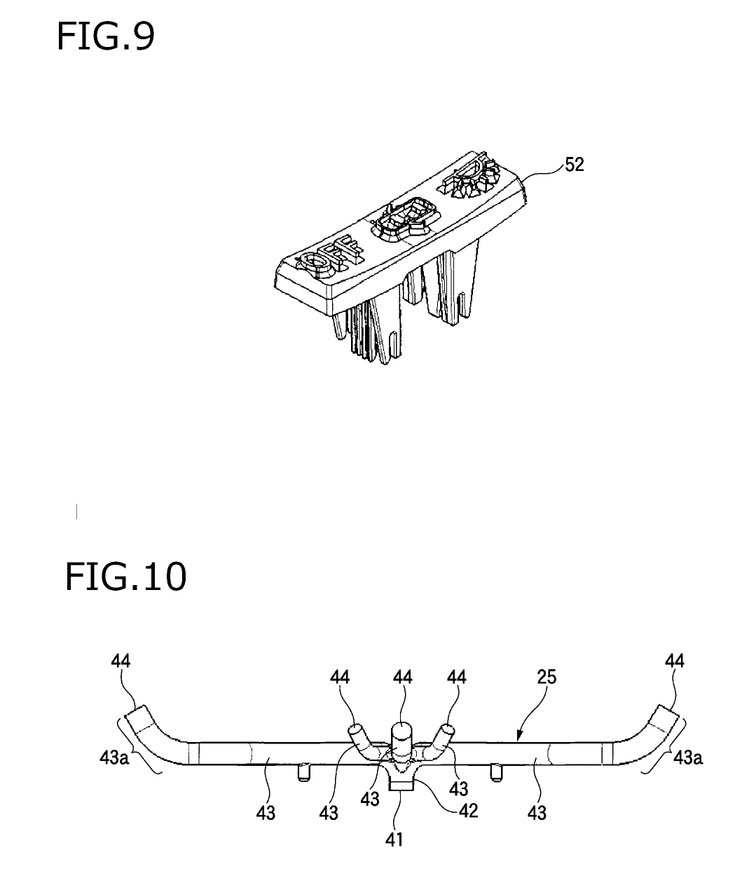

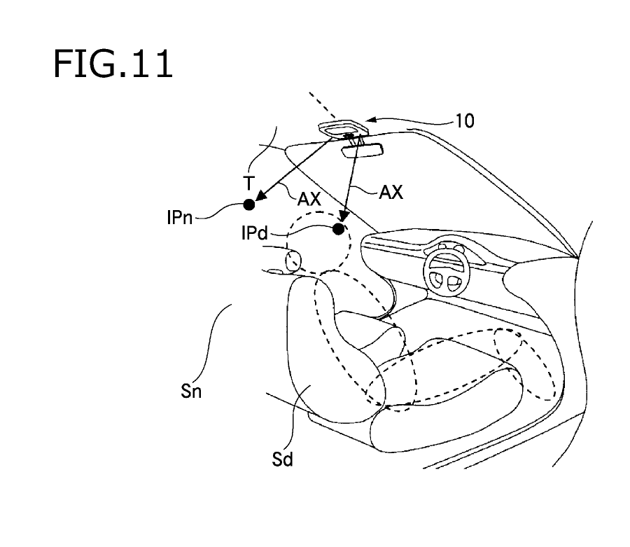

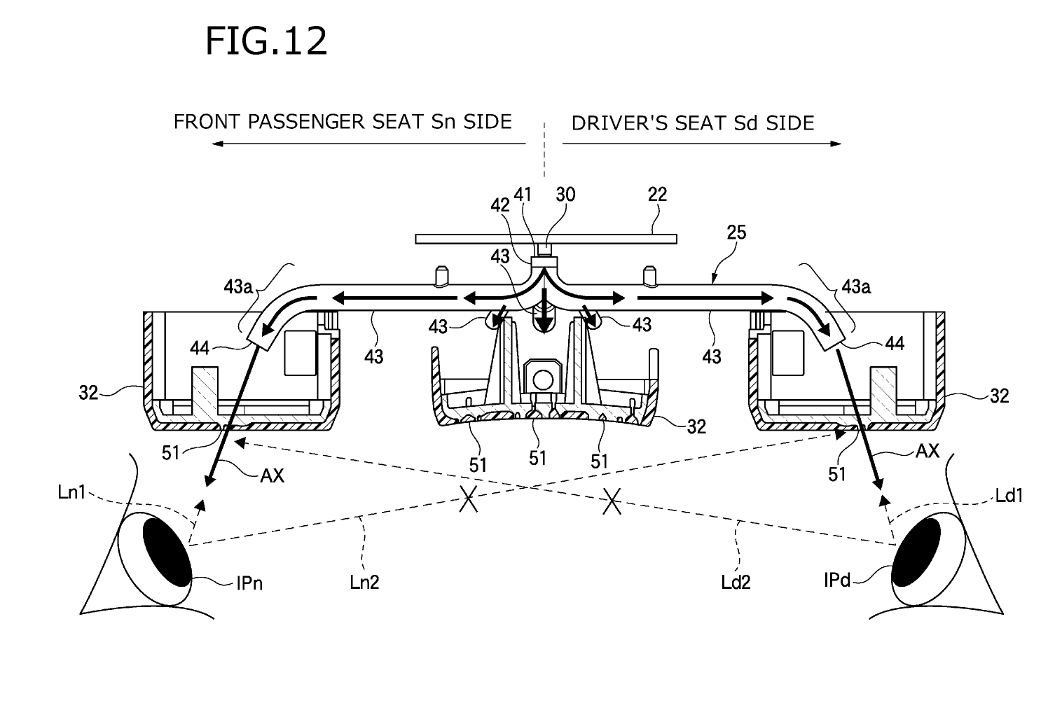

FIG. 5 is a perspective view of the switch with luminous indication portions according to the embodiment. FIG. 6 is a sectional view of the switch with luminous indication portions according to the embodiment. FIG. 7 is a perspective view of a switch knob. FIG. 8 is a plan view of the switch knob. FIG. 9 is a perspective view of a transparent portion of the switch knob. FIG. 10 is a front view of the light guide member. FIG. 11 is a perspective view showing a vehicle inside space in which the vehicular room illumination device is installed. FIG. 12 is a sectional view of the switch with luminous indication portions and shows its optical paths.

As shown in FIGS. 5 and 6, each switch knob 32 is provided with an indication portion(s) 51. The central switch knob 32 has three indication portions 51 and partitions 50 are formed between the indication portions 51.

As shown in FIG. 7, the switch knob 32 has transparent portions 52 that are made of a transparent resin and an opaque portion that is made of a colored resin. As shown in FIG. 8, in the indication portion 51 of each switch knob 32, part of the transparent portion 52 is exposed from the opaque portion 53 and an indication that indicates a function or the like of the switch is formed there.

This switch knob 32 is produced in the following manner. First, as shown in FIG. 9, transparent portions 52 with indications are molded with a transparent resin. Subsequently, an opaque portion 53 is molded outside the transparent portions 52 with a colored resin so as to be integrated with the transparent portions 52 (double molding).

In each switch knob 32, the indication(s) is viewable that is formed by the exposed portion(s) of the transparent portion(s) 52 in the indication portion(s) 51. That is, the function(s) or the like of the switch can be recognized by visually recognizing the indication(s) which is formed by the exposed portion(s) of the transparent portion(s) 52. Furthermore, since each switch knob 32 is illuminated from its back side, light that is incident on the transparent portion(s) 52 is output from the exposed indication portion(s) of the indication portion(s) 51. As a result, in each switch knob 32, the indication of the indication portion(s) 51 can be recognized visually even in dark places (e.g., at night). When the luminous indication(s) is recognized visually, the function(s) or the like of the switch can be understood.

As shown in FIG. 10, the light guide member 25 is made of a transparent material such as an acrylic resin and has a columnar light introduction portion 42 one end of which is formed with a light incidence surface 41. In the light guide member 25, plural branch light guide portions 43 branch off the light introduction portion 42 and end surfaces of the branch light guide portions 43 serve as light exit surfaces 44, respectively.

The two side branch light guide portions 43 lead to the back sides of the two side switch knobs 32, and portions 43a (hereinafter referred to as adjacent portions), adjacent to the light exit surfaces 44, of the light guide member are bent so that the light exit surfaces 44 are disposed near the indication portions 51 of the two side switch knobs 32, respectively. The three central branch light guide portions 43 lead to the back side of the central switch knob 32, and their light exit surfaces 44 are disposed near the respective indication portions 51 of the central switch knob 32.

The light incidence surface 41 of the light introduction portion 42 of the light guide member 25 is disposed at such a position as to be opposed to the light-emitting diode 30 which is mounted on the circuit board 22, whereby light emitted from the light-emitting diode 30 enters the light guide member 25 through the light incidence surface 41. The light that has entered the light guide member 25 through the light incidence surface 41 is guided to the branch light guide portions 43 and output through the light exit surfaces 44 of the respective branch light guide portions 43. As a result, the indication portions 51 of the respective switch knobs 32 are illuminated with the light emitted from the light-emitting diode 30 and guided by the light guide member 25.

The optical axes of light beams that are output from the light guide member 25 are positioned with respect to the centers of the respective indication portions of the switch knobs 32.

The adjacent portions 43a (which are adjacent to the light exit surfaces 44) of the two side branch light guide portions 43 are inclined so as to extend outward away from the center side. As a result, the optical axes of light beams that are output from the two side branch light guide portions 43 are set so that the light beams shine on the indication portions 51 of the two side switch knobs in directions that go outward away from the center side.

As shown in FIG. 11, the vehicular room illumination device 10 is attached to the ceiling at a position that is located over the boundary between the driver's seat Sd and the front passenger seat Sn in the vehicle. To illuminate the driver's seat Sd side, the driver's-seat-Sd-side bulb 28 is turned on by pushing the driver's-seat-Sd-side switch knob 32. To illuminate the front passenger seat Sn side, the front-passenger-seat-Sn-side bulb 28 is turned on by pushing the front-passenger-seat-Sn-side knob 32.

That is, in the switch with luminous indication portions of the vehicular room illumination device 10, the driver who is setting on the driver's seat Sd is a person who is to manipulate the driver's-seat-Sd-side switch knob 32 and the front passenger who is sitting on the front passenger seat Sn is a person who is to manipulate the front-passenger-seat-Sn-side knob 32.

In the switch with luminous indication portions according to the embodiment of the above-described vehicular room illumination device 10, as shown in FIG. 12, the adjacent portions 43a (which are adjacent to the light exit surfaces 44) of the two side branch light guide portions 43 are inclined so as to extend outward away from the center side. As a result, the optical axis Ax of light that is output from the driver's-seat-Sd-side branch light guide portion 43 is directed so as to reach the eye point IPd of the driver (the person who is to make a manipulation) who is sitting on the driver's seat Sd past the indication portion 51 of the driver's-seat-Sd-side switch knob 32. The optical axis Ax of light that is output from the front-passenger-seat-Sn-side branch light guide portion 43 is directed so as to reach the eye point IPn of the front passenger (the person who is to make a manipulation) who is sitting on the front passenger seat Sn past the indication portion 51 of the front-passenger-seat-Sn-side switch knob 32.

As described above, according to the embodiment, since light that is incident on the back side of each switch knob 32 passes the indication(s) of the indication portion(s) 51 and is output to the front-side space. As a result, indication(s) of the indication portion(s) 51 can be recognized visually even in dark places (e.g., at night).

In particular, the adjacent portions 43a (which are adjacent to the light exit surfaces 44) of the branch light guide portions 43 of the light guide member 25 that guide light emitted from the light-emitting diode 30 to the back sides of the two respective side switch knobs 32 extend toward the respective eye points IPd and IPn so that the light exit surfaces 44 are directed to the respective eye points IPd and IPn. As a result, the optical axes Ax of light beams that are emitted from the light-emitting diode 30 and output from the light exit surfaces 44 are directed to the respective eye points IPd and IPn of the persons who are to manipulate the respective switch knobs 32. Therefore, lines Ld1 and Ln1 of sight of the persons who are to make manipulations coincide with the respective optical axes Ax, whereby the indication portions 51 appear bright when the persons who are to make manipulations look at them. As a result, the viewability of the indication portions 51 of the switch knobs 32 for the persons who are to make manipulations can be enhanced greatly and the switch knobs 32 can be made easier to manipulate.

More specifically, the driver's-seat-Sd-side switch knob 32 is enhanced in its viewability from the driver (the person who is to make a manipulation) who is sitting on the driver's seat Sd. And the front-passenger-seat-Sn-side switch knob 32 is enhanced in its viewability from the front passenger (the person who is to make a manipulation) who is sitting on the front passenger seat Sn.

Furthermore, the indications of the indication portions 51 are less visible from positions other than the eye points IPd and IPn of the persons who are to make manipulations, which make it possible to suppress the probability of occurrence of an erroneous manipulation by a person other than the persons who are to make manipulations (i.e., a person not to make a manipulation).

More specifically, the optical axis Ax of the driver's-seat-Sd-side switch knob 32 does not coincide with the line Ln2 of the front passenger sitting on the front passenger seat Sn who is a person (a person not to make manipulation) other than the person who is sitting on the driver's seat Sd and is to make a manipulation. And the optical axis Ax of the front-passenger-seat-Sn-side switch knob 32 does not coincide with the line Ld2 of the driver sitting on the driver's seat Sd who is a person (a person not to make manipulation) other than the person who is sitting on the front passenger seat Sn and is to make a manipulation.

This makes it possible to prevent an erroneous manipulation that the front passenger sitting on the front passenger seat Sn who is a person (a person not to make manipulation) other than the person who is sitting on the driver's seat Sd and is to make a manipulation manipulates the driver's-seat-Sd-side switch knob 32 or the driver sitting on the driver's seat Sd who is a person (a person not to make manipulation) other than the person who is sitting on the front passenger seat Sn and is to make a manipulation manipulates the front-passenger-seat-Sn-side switch knob 32.

Next, another embodiment will be described. Constituent elements having the same ones in the above embodiment will be given the same symbols as the latter and descriptions therefor will be omitted.

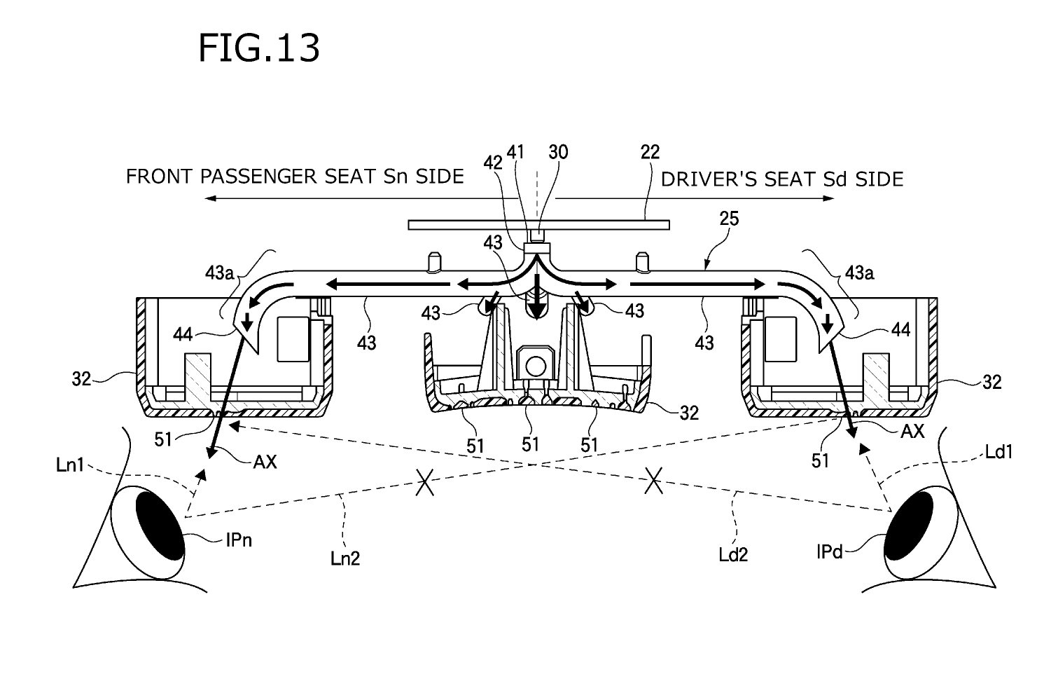

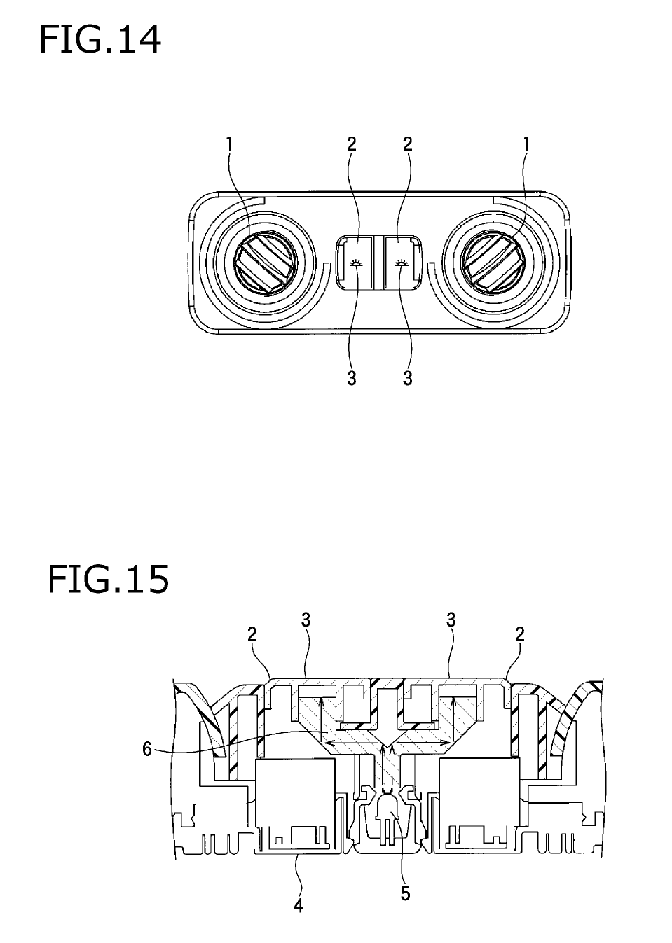

FIG. 13 is a sectional view of a switch with luminous indication portions according to the other embodiment and shows its optical paths.

As shown in FIG. 13, in this switch with luminous indication portions according to a vehicular room illumination device 10, portions, closest to the light exit surfaces 44, of the adjacent portions 43a (which are adjacent to the light exit surfaces 44) of the branch light guide portions 43 of the light guide member 25 that guide light emitted from the light-emitting diode 30 to the back sides of the two respective side switch knobs 32 extend approximately perpendicularly to the front surfaces of the respective switch knobs 32, respectively.

In the thus-disposed branch light guide portions 43 of the light guide member 25, the light exit surfaces 44 are inclined from the planes perpendicular to the extending directions of the portions, closest to the light exit surfaces 44, of the adjacent portions 43a of the branch light guide portions 43, respectively.

More specifically, in the driver's-seat-Sd-side switch knob 32, the light exit surface 44 is inclined from the plane perpendicular to the extending direction of the portion, closest to the light exit surface 44, of the adjacent portion 43a of the branch light guide portion 43 toward the eye point IPd of the driver who is sitting on the driver's seat Sd. In the front-passenger-seat-Sn-side switch knob 32, the light exit surface 44 is inclined from the plane perpendicular to the extending direction of the portion, closest to the light exit surface 44, of the adjacent portion 43a of the branch light guide portion 43 toward the eye point IPn of the front passenger who is sitting on the front passenger seat Sn.

With this measure, in the switch with luminous indication portions, the optical axes Ax of light that is output from the driver's-seat-Sd-side branch light guide portion 43 is directed so as to reach the eye point IPd of the driver (the person who is to make a manipulation) who is sitting on the driver's seat Sd past the indication portion 51 of the driver's-seat-Sd-side switch knob 32. The optical axis Ax of light that is output from the front-passenger-seat-Sn-side branch light guide portion 43 is directed so as to reach the eye point IPn of the front passenger (the person who is to make a manipulation) who is sitting on the front passenger seat Sn past the indication portion 51 of the front-passenger-seat-Sn-side switch knob 32.

As described above, also in the other embodiment, since light that is incident on the back side of each switch knob 32 passes the indication(s) of the indication portion(s) 51 and is output to the front-side space. As a result, indication(s) of the indication portion(s) 51 can be recognized visually even in dark places (e.g., at night).

In the other embodiment, the light exit surfaces 44 of the adjacent portions 43a (which are adjacent to the light exit surfaces 44) of the branch light guide portions 43 of the light guide member 25 that guide light emitted from the light-emitting diode 30 to the back sides of the two respective side switch knobs 32 are inclined from the planes perpendicular the extending directions of the portions, closest to the respective light exit surfaces 44, of the adjacent portions 43a so that the light exit surfaces 44 are directed to the respective eye points IPd and IPn. As a result, the optical axes Ax of light beams that are emitted from the light-emitting diode 30 and output from the light exit surfaces 44 are directed to the respective eye points IPd and IPn of the persons who are to manipulate the respective switch knobs 32. Therefore, lines Ld1 and Ln1 of sight of the persons who are to make manipulations coincide with the respective optical axes Ax, whereby the indication portions 51 appear bright when the persons who are to make manipulations look at them. As a result, the viewability of the indication portions 51 of the switch knobs 32 for the persons who are to make manipulations can be enhanced greatly and the switch knobs 32 can be made easier to manipulate.

Furthermore, the indications of the indication portions 51 are less visible from positions other than the eye points IPd and IPn of the persons who are to make manipulations, which makes it possible to suppress an erroneous operation the probability of occurrence of an erroneous manipulation by a person other than the persons who are to make manipulations (i.e., a person not to make a manipulation).

Although the above embodiments are directed to the case that the switch with luminous indication portions is installed in the vehicular room illumination device 10, the switch with a luminous indication portion(s) is not limited to ones installed in vehicular room illumination devices 10.

The invention is not limited to the above embodiments, and various modifications, improvements, etc. can be made as appropriate. The material, shape, dimensions, number, location, etc. of each constituent element of each embodiment are optional and no limitations are imposed on them as long as the invention can be implemented.

The features of the above-described switches with luminous indication portions according to the embodiments of the invention will be summarized concisely below as items [1]-[3]:

[1] A switch with a luminous indication portion comprising:

a switch (sub-busbar 23, main busbar 24, push switch 29);

a switch knob (32) which is provided in the switch and is configured to be manipulated in switching the switch; and

a light source (light-emitting diode 30) which illuminates the switch knob with light from a back side of the switch knob,

wherein the switch knob includes an indication portion (51) that is provided with a certain kind of indication;

wherein the indication provided in the indication portion is configured to transmit light coming from the light source; and

wherein an optical axis (Ax) of the light coming from the light source is directed to an eye point (IPd, IPn) of a person who is to manipulate the switch knob.

[2] The switch with a luminous indication portion according to item [1], further comprising a light guide member (25) which guides light emitted from the light source to the back side of the switch knob and emits the light through a light exit surface (44) as an end surface toward the indication portion,

wherein a portion, adjacent to the light exit surface, of the light guide member extends toward the eye point so that the light exit surface is directed to the eye point.

[3] The switch with a luminous indication portion according to item [1], further comprising a light guide member (25) which guides light emitted from the light source to the back side of the switch knob and emits the light through a light exit surface (44) as an end surface toward the indication portion,

wherein the light exit surface of the light guide member is inclined with respect to an extending direction of a portion, closest to the light exit surface, of the light guide member so that the light exit surface is directed to the eye point.

Although the invention has been described in detail by referring to the particular embodiments, it is apparent to those skilled in the art that various changes and modifications are possible without departing from the spirit and scope of the invention.

The present application is based on Japanese Patent Application No. 2013-090585 filed on Apr. 23, 2013, the disclosure of which is incorporated herein by reference.

### INDUSTRIAL APPLICABILITY

The invention makes it possible to provide a switch with a luminous indication portion(s) that is superior in the viewability from a person who manipulates it. Providing this advantage, the invention is useful in the field of switches with a luminous indication portion(s) in which the indication portion(s) lights being illuminated by a light source.

### DESCRIPTION OF SYMBOLS

23: Sub-busbar (switch)
24: Main busbar (switch)
25: Light guide member
29: Push switch (switch)
30: Light-emitting diode (light source)
32: Switch knob
43a: Adjacent portion
44: Light exit surface
51: Indication portion
Ax: optical axis
IPd, IPn: Eye point

1. A switch with a luminous indication portion, comprising:
a switch;
a switch knob that is provided in the switch and is configured to be manipulated in switching the switch; and
a light source that illuminates the switch knob with light from a back side of the switch knob,
wherein the switch knob comprises an indication portion that is provided with a certain kind of indication;
wherein the indication provided in the indication portion is configured to transmit light coming from the light source; and
wherein an optical axis of the light coming from the light source is directed to an eye point of a person who is to manipulate the switch knob.

2. The switch with a luminous indication portion according to claim 1, further comprising:
a light guide member that guides light emitted from the light source to the back side of the switch knob and emits the light through a light exit surface as an end surface toward the indication portion,
wherein a portion, adjacent to the light exit surface, of the light guide member extends toward the eye point so that the light exit surface is directed to the eye point.

3. The switch with a luminous indication portion according to claim 1, further comprising:
a light guide member that guides light emitted from the light source to the back side of the switch knob and emits the light through a light exit surface as an end surface toward the indication portion,
wherein the light exit surface of the light guide member is inclined with respect to an extending direction of a portion, adjacent to the light exit surface, of the light guide member so that the light exit surface is directed to the eye point.
